(19) United States
(12) Patent Application Publication
(10) Pub. No.: US 2019/0202114 A1
(43) Pub. Date: Jul. 4, 2019

(54) ADDITIVE MANUFACTURING METHOD

(71) Applicant: Ford Global Technologies, LLC, Dearborn, MI (US)

(72) Inventors: Raphael Koch, Odenthal (DE); Lars Bognar, Dormagen (DE); Bruno Alves, Huerth (DE)

(73) Assignee: Ford Global Technologies, LLC, Dearborn, MI (US)

(21) Appl. No.: 16/237,855

(22) Filed: Jan. 2, 2019

(30) Foreign Application Priority Data
Jan. 2, 2018 (DE) 102018200010.7

(51) Int. Cl. B29C 64/153; B33Y 10/00; B29C 64/205; B22F 1/00

(52) U.S. Cl. CPC B29C 64/153; B22F 1/0059; B29C 64/205; B33Y 10/00

(57) ABSTRACT

An additive manufacturing method includes manufacturing a workpiece in a manufacturing area by applying metallic powder with a first application device, layer by layer, to a base body. The metallic powder is melted in first regions by a laser beam and solidified. In order to improve the efficiency of selective laser melting, support structures that connect the workpiece to the base body are produced by applying a binder to the powder in second regions with a second application device and solidifying the second regions to produce a powder-binding binder matrix. The support structures are removed from the workpiece after completion thereof by breaking up the binder matrix by degradation with respect to which the workpiece is stable.

### CROSS-REFERENCE TO RELATED APPLICATIONS

This application claims priority to and the benefit of German Application No. 102018200010.7, filed on Jan. 2, 2018. The disclosure of the above application is incorporated herein by reference.

### FIELD

The present disclosure relates to an additive manufacturing method.

### BACKGROUND

The statements in this section merely provide background information related to the present disclosure and may not constitute prior art.

There nowadays exist various methods by means of which, based on construction data, three-dimensional models can be produced from shapeless or shape-neutral materials such as powders (optionally with addition of a binder) or liquids (which also includes solids that have been melted temporarily). These methods are also known by collective terms such as “rapid prototyping,” “rapid manufacturing” or “rapid tooling.” It is often the case here that a primary forming step takes place, in which the starting material is either in liquid form from the outset or is intermediately liquefied and cures at the intended site. A known method in this context is called melt coating (fused deposition modeling, FDM), in which a workpiece is constructed layer by layer from thermoplastic material. The plastic is supplied, for example, in pulverulent or strand form, melted and applied in molten form by a printhead that successively applies individual, generally horizontal layers of the object to be produced.

In addition, there are known methods in which a pulverulent substance, for example a plastic, is applied layer by layer and cured selectively by means of a locally applied or printed-on binder. In other methods again, for example selective laser sintering (SLS), a powder is applied, for example by means of a coating bar, layer by layer to a baseplate. The powder is selectively heated by means of suitable focused radiation, for example a laser beam, and thereby sintered. After one layer has been constructed, the baseplate is lowered slightly and a new layer is applied. Powders used here may be plastics, ceramic or metals. The unsintered powder has to be removed after the production process. In a similar process, selective laser melting (SLM), the amount of energy introduced by the radiation is so high that the powder is melted in regions and solidifies to form a coherent solid. This method is employed in the case of metallic powders in particular.

In many cases, it is necessary, as well as the actual usable form of the object, to additionally produce connecting structures or support structures that connect the object to the baseplate. These may be columns, struts, stilts or similar elements that normally run vertically. These serve firstly to assure reliable support in the case of overhanging shapes and to prevent parts of the object from moving in the manufacturing process. Secondly, particularly in the case of manufacturing methods associated with significant introduction of heat, support structures ensure removal of heat from the object to the baseplate and prevent the object from warping in the course of manufacture as a result of differences in temperature. The input of heat is significantly higher in SLM than in SLS, for example, and for that reason the support structures are generally absolutely necessary in the former process for thermal reasons in order to assure controllable manufacture. At the same time, support structures have to have sufficient thermal conductivity, which can be achieved in that they are likewise manufactured by SLM from the same metallic powder as the utilizable object.

When the manufacture of the object is complete, it has to be removed from the baseplate together with the support structures, for which purpose the baseplate generally has to be removed from the manufacturing apparatus. Traditionally, the manual separation of the object from the baseplate is normally effected by spark erosion (EDM, electrical discharge machining), more specifically wire erosion, or by mechanical means, for example by means of a saw. Apart from the time taken, a drawback exists in the case of wire erosion that the wire has a tendency to break on contact with metal powder. After the removal, further processing of the object is often necessary in order to remove residues of the support structures. All this means high time demands and an increase in costs. Owing to the drawback indicated, methods such as SLM are currently unsuitable for economically viable mass production.

U.S. Patent Publication No. 2015/0028523 A1 discloses a method of additively manufacturing a workpiece in which support structures are produced from a material containing a specific polyglycolic acid polymer. The actual workpiece is produced from a different material. The additive manufacture can be effected by extrusion or selective laser sintering or in an electrophotography-based manner. The material of the support structures can be dissolved by means of an aqueous, for example alkaline, solvent.

U.S. Patent Publication No. 2016/0122541 A1 discloses a process for producing a three-dimensional workpiece by additive manufacture, in which, in a heated chamber, a first material for manufacture of the actual workpiece and a second material for manufacture of support structures on the workpiece are applied layer by layer selectively in liquid form. The second material comprises a base resin and a dispersion resin dispersed therein. The two resins are mutually immiscible, which is intended to bring about structural weakening of the support structures, which is intended to make it easier to break them away from the workpiece.

CN 104786507 A discloses a platform for a 3D printer. The platform comprises a base body and a coating film applied thereto. The coating film consists of a material that can be dissolved in a suitable solvent. What is envisaged is that a three-dimensional object is constructed on the platform and, after completion thereof, the coating film is detached, which detaches the object from the base body which can subsequently be coated again.

U.S. Patent Publication No. 2016/0185050 A1 discloses a printer cartridge for a 3D printer. The cartridge comprises a coil with a thermoplastic polymer material that comprises a matrix polymer and two additives dispersed therein. The polymer material is supposed to be both flexible and dimensionally stable. It can be used for additive manufacture of workpieces and of support structures. For support structures, however, it is also possible with preference to use a different material that can be dissolved in water or in an aqueous alkaline solution.

As outlined above, the efficiency of the manufacture of workpieces by selective laser melting still has a number of drawbacks. The teachings of the present disclosure address these drawbacks and assure the thermal and mechanical functionality of the support structures while simultaneously enabling more efficient separation thereof from the utilizable workpiece.

### SUMMARY

This section provides a general summary of the disclosure and is not a comprehensive disclosure of its full scope or all of its features.

The present disclosure improves the efficiency of a method of selective laser melting.

It should be pointed out that the features and measures detailed individually in the description which follows can be combined with one another in any technically meaningful manner and show further configurations of the present disclosure. The description additionally characterizes and specifies the present disclosure, particularly in connection with the figures.

The present disclosure provides an additive manufacturing method. The method can be assigned to the field of rapid prototyping or rapid manufacturing. As will yet become clear, however, it is suitable not just for manufacturing of prototypes or individual models, but more particularly also for mass production.

In the method of the present disclosure, a workpiece is manufactured by, in a manufacturing area, applying metallic powder by means of a first application device layer by layer to a base body, melting it in regions by means of a laser beam and solidifying it.

The manufacturing area here is the area in which the actual manufacture or actual construction of the workpiece is effected. Metallic powder here refers to any pulverulent or particulate material including at least one metal. It may also be an alloy or a mixture of particles of different metals. The powder may also contain semimetals or nonmetals, for example as a constituent of an alloy. Useful metals include aluminum, titanium and iron.

The first application device applies one layer of said powder in each case across a construction surface. The layer thickness may, for example, be between 10 μm and 500 μm, although other layer thicknesses are also conceivable. Such an application device may have one or more release openings from which the powder exits, for example in the direction of gravity. In order to enable a smooth and homogeneous layer construction, the first application device may including a smoothing device, for example a coating bar, brush or blade, which is moved parallel to the construction surface and smooths the surface of the powder. In general, the construction surface is flat, which means that it is also possible to refer to a construction plane. The application here is effected layer by layer to a base body, meaning that the first layer is applied directly to the base body, and then the further layers are applied successively on top.

In one form, the base body has a flat surface aligned parallel to the construction surface. The base body may especially also take the form of a baseplate or ground plate or have a baseplate. The base body may include, at least predominantly, of a material having high thermal conductivity, for example a metal. After the application of a respective layer, the powder is melted in some regions by a laser beam and subsequently solidifies. In this way, the powder forms a coherent solid. At the same time, the powder of the last added layer is fused to the solid-state structures of the layer beneath or multiple layers beneath, which establishes coherence of the layers with one another. Depending on the layer thickness among other factors, it is possible that the laser beam melts the material down to a depth corresponding to multiple layer thicknesses.

For the purposes of a targeted manufacturing method, the laser beam here normally acts in accordance with a particular pattern. It could also be said that a predetermined area is irradiated. It is possible here that, for example, the surface is scanned by a tightly focused laser beam or else that a particular radiation pattern is projected at the same time. Various scanning patterns are possible; for example, the outline of a surface can first be scanned and then its interior, or vice versa. The laser beam is generally aligned with respect to the construction surface not by movement of a laser itself but in that a beam generated by the laser is deflected by means of at least one movable mirror. It will be apparent that the three-dimensional or time-related radiation pattern of the laser beam can be controlled in accordance with defined data (e.g. CAM data) of a workpiece to be produced. The irradiated area corresponds here to a (generally flat) cross section of the workpiece. Overall, this method can be classified as “selective laser melting” (SLM), or as “application welding.”

During the layer-by-layer application, melting and solidification, the base body together with the workpiece is normally transported away from the construction surface by means of a transport device. A corresponding transport direction thus runs at an angle, i.e. in a nonparallel manner, to the construction surface. It will be apparent that the transport is normally intermittent, i.e. discontinuous, in that a layer is applied while the transport device is stationary, and the base body together with the workpiece is transported onward (corresponding to one layer thickness) when the layer has been fully applied. The action of the laser beam is also normally effected with the base body at rest. However, continuous transport would also be theoretically possible, in which case it would be desirable to match the movement of the application device and the control of the laser beam to the movement of the transport device. The layer-by-layer construction outlined and the successive transporting of the base body together with the workpiece is continued until the workpiece is ultimately completed (for example in accordance with underlying CAM data).

With regard to the alignment of the construction surface and the transport direction, different configurations are possible, some of which are discussed hereinafter. The base body may in each case have a surface that runs parallel to the construction surface. It is likewise generally economic for the angle between the transport direction and the construction plane not to be too small, for example at least 30°. The construction surface may run horizontally or else at an angle to the horizontal, but one that is less than the angle of repose of the metallic powder. The transport direction may run vertically (especially in the case of a horizontal construction surface) or else at an angle to the vertical. If the construction surface runs at an angle to the horizontal, the transport direction may also be horizontal.

The base body in the method of the present disclosure does not just constitute a mechanical substrate for the manufacture of the workpiece; instead, it also has an important function for dissipation of heat. The melting of the powder may cause heating (considerable in some cases) of the manufactured workpiece even after the solidification. Good release of heat from the workpiece is not possible to surrounding gases or through loose powder that adjoins the workpiece, since both are relatively poor heat conductors. Since, however, the workpiece is constructed atop the base body, heat can be dissipated to the base body, which inhibits excessive heating of the manufactured workpiece. This also at least substantially inhibits thermal deformation, for example bending of the workpiece. Without the presence of the base body, the workpiece could deform so severely that the application of a subsequent powder layer, for example, would be hindered.

In addition, in the method of the present disclosure, support structures that connect the workpiece to the base body are produced by applying a binder to the powder in regions by means of a second application device and solidifying it to give a powder-binding binder matrix. The support structures here are pure auxiliary structures that are not part of the desired final shape of the workpiece. They fulfill various functions. For instance, they can serve for mechanical stabilization, for example by stabilizing the workpiece during manufacture and any further transport and inhibiting tilting of the workpiece. They secondly serve to improve the thermal connection to the base body, such that heat can be dissipated better from the workpiece. In addition, they are generally arranged between the base body and the workpiece such that the latter is connected to the base body only indirectly via the support structures. This makes it possible in a simple manner to separate the workpiece from the base body without damage. More particularly, the support structures here can extend at right angles to the construction surface. They may take the form of columns, struts, stilts or the like. They can also have an interrupted, for example grid-, mesh- or honeycomb-like, structure.

The binder here is applied specifically and locally to the regions that are to correspond to support structures. Typically, the binder is applied in liquid form, which includes the possibility that the binder is solid at ambient temperature and is heated and hence temporarily liquefied for application to the powder. Normally, the binder, however, is liquid at ambient temperature and, after being applied to the powder, cures owing to a chemical reaction. The expression “the binder” here includes the possibility that it is a mixture of two components that react with one another and hence bring about the curing process. It would also be possible to accelerate or induce the curing in a controlled manner, for example by means of a UV light source that irradiates the binder. Thermal acceleration of the curing would also be conceivable, for example in that the laser beam acts on the binder, but a lower energy input should normally be established than in the regions in which the metal powder is melted. It is especially possible to use binders that can also withstand high temperatures that can arise in contact with molten metal powder. Examples of these are binders based on furan resin or phenolic resin. Binders of this kind are also used, for example, in the 3D printing of sand molds that are used for casting of metal parts, and therefore have high thermal stability.

The second application device may have a kind of printhead that effectively “prints” the binder onto the powder by means of one or more nozzles. The binder is normally applied in such a way that it surrounds the metallic powder within a thin layer close to the construction surface, which means that this powder is incorporated into the cured binder matrix that forms. It can also be said that the binder matrix binds or incorporates metallic powder. Such a process can also be referred to as “binder jetting.” The binder matrix here fulfills two functions. It firstly provides the mechanical integrity of the support structures. Secondly, dissipation of heat from the workpiece to the base body takes place through the support structures and hence partly also through the binder matrix. A normally predominant proportion of the support structures by volume is taken up by metallic powder. In general, there is contact between adjacent powder particles, albeit only point contact, and so a certain proportion of the heat transport is effected by means of the binder matrix that fills the interstices between the particles. The binder matrix generally has lower thermal conductivity than the metal powder enclosed, but its thermal conductivity is typically at least one order of magnitude greater than that of gases. Thus, the thermal conductivity of the support structures is significantly greater than that of the loose metallic powder where the interstices between individual particles are filled with gas. In some cases, the melting of metallic powder enables breakdown of the binder matrix in immediately adjacent areas. In these cases, the connection between the support structures and the workpiece can possibly be maintained by means of metal particles that have been sintered on, which generate form fitting on the micro-scale and simultaneously provide dissipation of heat.

The process steps of the melting of powder and the application of binder can be conducted in a different sequence in time or else in parallel. These steps are at least largely independent of one another since the powder is either being melted in a particular part of the application area or is being provided with binder, but not both.

Typically, the method is conducted at least partly within a housing that can at least partly encase the first and second application devices, for example. By means of such a housing, it is firstly possible to inhibit powder from leaving the actual manufacturing area in an uncontrolled manner and hence contaminating other areas. More particularly, however, it is possible in a simpler manner within such a housing to conduct at least parts of the method in an inert gas atmosphere, or in an inert gas-enriched atmosphere that has a distinctly reduced oxygen content compared to air, which can inhibit oxidation or even combustion or explosion of the metallic powder.

The temperature of the base body and the workpiece can optionally be controlled during or after the manufacture by means of a heating apparatus and/or a cooling apparatus. Such temperature control can serve, for example, to reduce any intrinsic stresses or to subject the workpiece to a thermal aftertreatment. In this case, the desired final shape of the workpiece (i.e. the utilizable part thereof) is fixed on the base body by means of the support structures and thus safeguarded from warping.

After completion of the workpiece, the support structures are removed therefrom by breaking up the binder matrix by means of degradation with respect to which the workpiece is stable. Since the support structures are not part of the actual workpiece, they are removed after completion thereof, which includes the possibility that there are other intermediate process steps between the completion and the removal. For removal of support structures, the binder matrix is broken up; it could also be said that it is separated or degraded. The integrity of the binder matrix is dissolved or destroyed at least in regions, which means that the binder matrix breaks down into individual parts that may possibly also be individual molecules, atoms or ions. Means, which are referred to here as means of degradation, are used in order to break up the binder matrix. These means are selected such that the workpiece is stable or insensitive thereto. “Stable” means here that action of these means cannot damage (or permanently alter) the workpiece, or do so at most to a slight degree which is unimportant in respect of the method. In other words, the fact that the binder matrix has different material properties than the actual workpiece is exploited. Since the workpiece is in metallic form, it generally has greater mechanical stability than the binder matrix. With regard to other physical or chemical properties too, the workpiece can be more stable or less sensitive than the binder matrix. The breakup of the binder matrix in many cases means that the support structures are not simply removed from the workpiece, but are broken up in their entirety into parts (possibly individual molecules etc.).

In the method of the present disclosure, the removal of the support structures does not involve any special care or manual activity. This is because the means of degradation used cannot damage the workpiece itself, by contrast with the prior art, where the support structures consist of the same material as the workpiece, which means that any means of removing the support structures can also damage the workpiece. This fact simplifies the removal of the support structures and enables it to be conducted in a partly or fully automatic manner. Thus, the method of the present disclosure can be conducted rapidly, efficiently and inexpensively. In particular, it is also suitable for mass production, and likewise for the rapid and inexpensive production of models or prototypes. Under some circumstances, the binder matrix can also be broken up with comparatively low energy expenditure, such that, by comparison with the prior art, an energy saving is also possible. In each case, the breakup of the binder matrix is normally found to be simpler than severance of the metallic material of which the workpiece and, in the prior art, the support structures too consist. Nevertheless, the support structures have thermal conductivity by virtue of the binder matrix and the intercalated metallic powder particles, which means that effective dissipation of heat from the workpiece to the base body is possible. A further advantage is that the generation of the support structures does not result in any particular introduction of heat, if any. This contrasts with the prior art, where the support structures are generated by melting of powder, which in itself contributes to increasing the thermal issues.

Although the removal of the support structures from the workpiece is effected in the inventive manner described above, it is possible that the support structures or a portion thereof are separated from the base body beforehand in a conventional manner. Useful “conventional” methods here include, for example, cutting-off, sawing or machining and/or other suitable methods, for example water-jet cutting, laser cutting or erosion.

A great advantage in the method of the present disclosure is that the means of degradation are chosen such that damage to the workpiece thereby is reduced. In one configuration, the means of degradation also act at least on regions of the workpiece. This means that effectively the entire arrangement composed of workpiece and support structures (and optionally the base body) can be exposed to the means of degradation without any need for these to be limited to the support structures. The means of degradation can thus effectively act over a large area. As already set out above, this simplifies the method regime.

In another configuration, the binder matrix is broken up by the action of a mechanical vibration, especially in the ultrasound range. In other words, in this case, the mechanical vibration that the support structures (and normally also the workpiece) are induced to create is a means of degradation. The mechanical vibration, which can also be referred to as oscillating movement or as a soundwave, produces different mechanical stresses locally in the solids that are affected thereby, which can lead to fractures. It is possible here firstly to exploit the fact that the material of the binder matrix is more sensitive to other frequencies than the workpiece, and secondly that the metallic workpiece generally has a certain flexibility higher than that of the binder matrix. Therefore, the binder matrix can also have a certain porosity by contrast with the workpiece that has been molten or welded in its entirety. The reasons mentioned here for a greater sensitivity of the binder matrix to a vibration, especially a vibration in the ultrasound range, may be present individually or together, and other reasons are also conceivable as well. In this respect, the description of the underlying mechanisms should in no way be interpreted restrictively. In any case, it is possible, by the action of the vibration, to break up or destroy or to segment the binder matrix, while the workpiece remains intact. The vibration can be applied in different ways, for example via surrounding air (or another gas or gas mixture), via a liquid in a vessel into which the support structures and optionally the workpiece are immersed, or via direct or indirect contact of the workpiece with an ultrasound generator. For example, the workpiece together with the support structures can be placed in a vessel in direct contact with the ultrasound generator.

In a further form, the binder matrix is dissolved by the action of a liquid solvent. In this case, the liquid solvent should be regarded as the means of degradation. The composition of the solvent does of course depend on the composition of the binder matrix. The solvent here can dissolve the binder matrix based on different physical and/or chemical processes, which also includes the possibility that the solvent reacts chemically with the binder matrix. The possibility discussed here is advantageous in that (given a sufficient amount of solvent) the binder matrix can be removed completely. It will be apparent that the solvent has to be chosen in such a way that it attacks the workpiece only to a degree unimportant in respect of the method, if at all. Normally, the binder matrix can also be removed completely from the metal powder that has temporarily been incorporated therein without it being attacked. The dissolution of the binder matrix may additionally be accelerated by the action of a mechanical vibration, especially an ultrasound vibration. It is possible here that the dissolution of the binder matrix and the mechanical breakup supplement one another.

Different methods of applying the solvent to the support structures are possible, such that the binder matrix is dissolved as intended. More particularly, the support structures can be contacted with the solvent by at least one of dipping, pouring it over and spraying. In the case of immersion, the entire workpiece including the support structures (and optionally the base body) is immersed into a vessel containing solvent. In the case of pouring-over, the solvent is poured at least over the support structures from the top in the manner of a shower, whereas, in the case of spraying, the solvent can be applied under pressure from above, from the side and/or from beneath. While large-area contact with the solvent can be implemented particularly efficiently by dipping, a respective site on the support structures can be constantly brought into contact with fresh solvent in the case of pouring-over and in the case of spraying, which accelerates the dissolving operation. In the case of dipping, however, it is also possible to keep solvent in motion by means of stirrers or the like, which likewise accelerates the dissolving operation. The methods presented can also be combined with one another, and they can be conducted simultaneously or successively.

With regard to the movement of the two application devices, there are two options. In a first configuration, movement of the second application device is coupled to movement of the first application device. The two application devices here are normally mounted mechanically in a fixed position relative to one another and are moved together across the construction surface. This configuration is advantageous in that the metallic powder can be applied and can be bonded in regions by binders with just one operation. In mechanical terms, it is desirable here to move just one assembly and to coordinate the binder release with the corresponding movement. In a second configuration, the movement of the second application device is independent of the movement of the first application device. This may be advantageous in that the second application device has to be moved only to the regions that actually have to be provided with binder in the current layer. It is possible here for the two application devices nevertheless to work in parallel in time, meaning that the second application device can already be applying binder while the first application device is still applying metallic powder.

In one aspect, the base body together with the workpiece, after completion thereof, is removed from the manufacturing area and transported into a processing area in which the support structures are removed. The transport can of course be effected in an automated manner by means of grabs, magnets, continuous conveyors or other suitable devices. The support structures are removed in a removal area arranged at a distance from the manufacturing area. This in turn means that the manufacturing area becomes free again for manufacture of a further workpiece on a further base body. For this purpose, it is not necessary to wait until the previously manufactured workpiece has been freed of the support structures. Under some circumstances, the time involved for the transport to the processing area can serve for cooling of the base body, the support structures and/or the workpiece within an appropriate time. This may be important, for example, when contact with a solvent could impair either the finished workpiece or the solvent if the temperature of the workpiece is too high.

The method of the present disclosure serves primarily for removal of the support structures in an efficient manner from the manufactured workpiece without risking damage to the workpiece. Removal of the support structures from the base body could be effected in a conventional manner by sawing, for example, in which case it would be possible to work with low precision and hence quickly, after which the removal from the workpiece is effected in the manner according to the present disclosure. In addition, however, it is also possible that the support structures are also removed from the base body by the action of the means of degradation, in which case the base body is stable with respect to the means of degradation. This is efficiently possible, for example, when the base body as described above is at least partly metallic and hence has similar (or identical) properties to the finished workpiece.

Especially when the support structures are also being removed from the base body by the action of the means of degradation, it can subsequently be regarded as having been essentially cleaned, which means that reuse is possible. In one development of the method, after the removal of the support structures, the base body is reused. Additionally or alternatively, powder bound temporarily within the binder matrix may be reused. Especially when the binder matrix has been dissolved by a solvent, the metallic powder that was bound by the binder can be recovered and reused.

This option is important especially when the powder is, for example, a high-value alloy and/or the mass of the support structures is comparatively high compared to the finished workpiece. Under some circumstances, it may be desirable to continue the treatment of the base body or of the powder after the support structures have already been removed from the workpiece to a sufficient degree. It is even possible here that powder recovered is automatically returned to the first application device. There may be a need here for an intermediate processing operation or sorting and sieving of the powder. Automatic recycling of the base body is also conceivable.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic diagram of the production of a workpiece with support structures according to the method of the present disclosure;

FIG. 2 shows an enlarged section diagram of a detail from FIG. 1;

FIGS. 3A-3C show a schematic diagram of the removal of support structures in a first form of the method of the present disclosure; and

FIGS. 4A-4C show a schematic diagram of the removal of support structures in a second form of the method of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

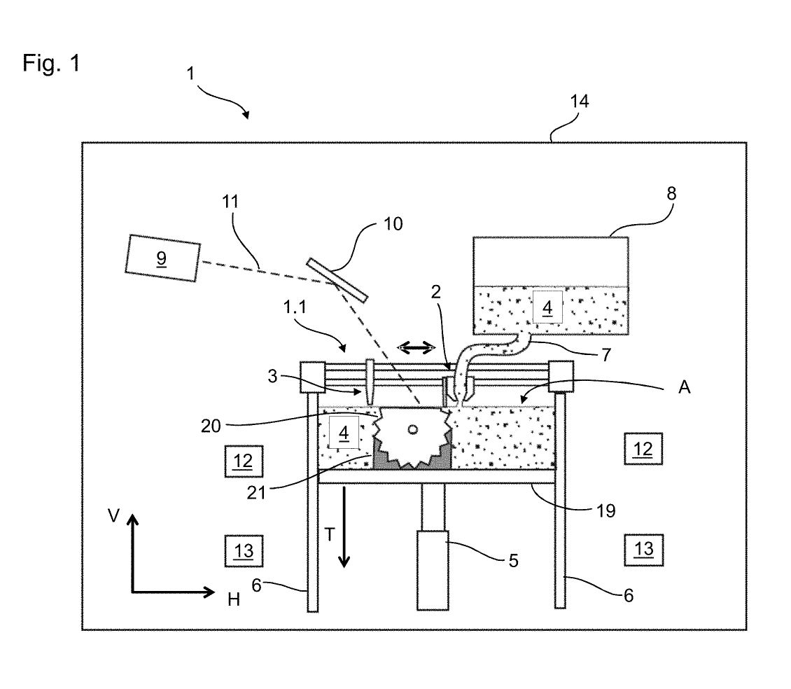

FIG. 1 shows one form of a manufacturing plant 1 that can be used in the additive manufacturing method of the present disclosure. The diagram here, as in the other figures too, is highly schematic.

On a lifting device 5 is supported a baseplate 19, on which a workpiece 20 is produced in a manufacturing area 1.1 by additive manufacture. The workpiece 20 here takes the form of a cog by way of example. By means of a powder application device 2, metallic powder 4 is applied to the baseplate 19 layer by layer across a construction surface A. The construction surface A runs parallel here to the surface of the baseplate 19 and parallel to the horizontal H.

The powder application device 2 may have a kind of nozzle or valve for powder release and have a smoothing device, for example a coating bar. As indicated by the double-headed arrow, the powder application device 2 can be moved parallel to the construction surface A in order to distribute powder 4 across the entire construction surface A. The baseplate 19 is adjoined laterally by side walls 6 that inhibit powder 4 from trickling off to the side.

When the powder application device 2, connected via a supply conduit 7 to a reservoir vessel 8, has applied a layer of metal powder 4, some of the powder 4 is selectively melted by means of a laser beam 11, which creates a layer of a workpiece 20 to be manufactured. In order to inhibit oxidation or even explosion of the powder 4, the entire manufacturing plant 1 is disposed within a housing 14 filled with inert gas, or into which inert gas is blown continuously, which keeps the oxygen content low.

The laser beam 11 is generated by a laser 9 and directed by means of a pivotable mirror 10 onto an envisaged coordinate point within the construction surface A. The activation of the laser 9 and the control of the mirror 10 are effected by computer control according to defined CAM data of the workpiece 20. The lifting device 5 in the present example is operated intermittently, meaning that it is stopped while a powder layer is being applied and partly melted, and then transports the baseplate 19 together with the workpiece 20 in a transport direction T from the construction surface A onward by a distance corresponding to the envisaged layer thickness. The transport direction T in the present example runs parallel to the vertical V. It is optionally possible to provide a cooling device 12 and/or a heating device 13 in order to control the temperature of the manufactured workpiece 20 or the surrounding powder 4.

The action of the laser beam 11 significantly heats the workpiece 20 produced, although the molten powder solidifies again once the action of the laser beam 11 has ended. Since effective release of heat is not possible either to the surrounding powder 4 or to the inert gas, for avoidance of thermal deformations of the workpiece 20, it is desirable for heat to be released to the baseplate 19. In order to promote this, apart from the workpiece 20, support structures 21 are also generated that connect the former to the baseplate 19. These support structures 21 firstly stabilize the workpiece 20, but in particular serve for better dissipation of heat into the baseplate 19. The support structures 21 extend transverse to the construction surface A between the baseplate 19 and the workpiece 20, such that it is only connected indirectly to the baseplate 19 via the support structures 21.

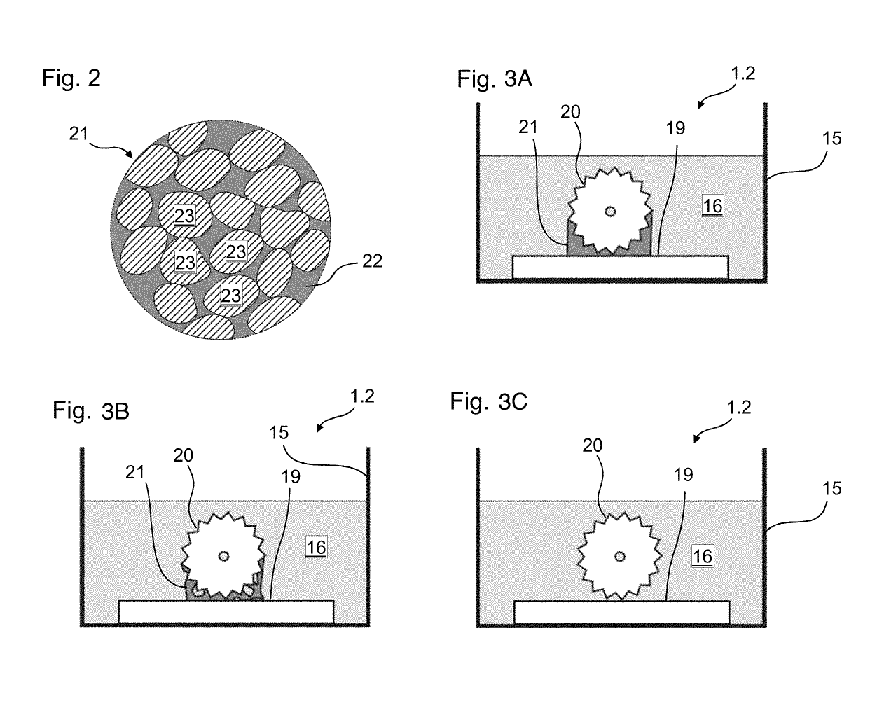

The support structures 21 are constructed in that a binder application device 3 applies a binder to regions of the powder 4. The binder application device 3 which may have a nozzle, for example, for release of the binder can move parallel to the construction surface A. The binder is applied in liquid form, surrounds particles 23 of powder 4 and cures to form a binder matrix 22. FIG. 2 shows a highly enlarged section diagram of a detail of the support structure 21. The thermal conductivity of the respective support structure 21 is determined firstly by the metallic particles 23 between which direct conduction of heat is possible in part owing to contacts, and secondly by the binder matrix 22 that bridges the interstices between the particles 23, which gives significantly better conduction of heat than in the case of loose powder 4. In particular, this is associated with the fact that the thermal conductivity of the binder matrix 22 is typically at least one order of magnitude greater than that of the gases within the housing 14. Therefore, effective dissipation of heat is possible by means of the support structures 21 even though they are only partly metallic. The binder is released through the binder application device 3 under computer control according to defined CAM data of the support structures 21. In the example shown here, the movement of the binder application device 3 is independent of that of the powder application device 2. Alternatively, however, it would also be possible to couple the binder application device 3 to the powder application device 2. The binder release and the melting of the powder 4 by the laser beam 11 can in principle be conducted in any sequence successively or else in parallel within a layer.

Once the layer-by-layer construction of the workpiece 20 is complete, the baseplate 19 together with the finished workpiece 20 can be removed from the lifting device 5. This can be done automatically, as can the transfer of the baseplate 19 to a processing area 1.2 in which the support structures 21 are removed.

FIGS. 3A-3C show the removal of the support structures 21 in a first variant. The baseplate 19 together with the workpiece 20 and the support structures 21 is introduced here into a tank 15 containing solvent 16. The solvent 16 is selected such that it dissolves the binder matrix 22, but has only a minimal superficial effect at most, if any, on the workpiece 20, the baseplate 19 and the particles 23 incorporated in the binder matrix 22. As shown in FIG. 3B, the support structures 21 gradually dissolve as a result of breakup of the binder matrix 22 until the workpiece 20, just like the baseplate 19, is ultimately released (FIG. 3C). The workpiece can then be removed from the solvent 16 and used (optionally after rinsing the solvent off and/or drying). Correspondingly, it is also possible to reuse the baseplate 19 in the manufacturing plant 1. It is even possible to reuse the particles 23 of the powder 4 that were incorporated temporarily in the binder matrix 22. It would be possible here to recover the powder 4 from the solvent 16, for example by filtration, and to recycle it into the reservoir vessel 8 (optionally after rinsing and drying).

Although the solvent 16 is being used here in the form of a bath, it could also be poured or sprayed under pressure onto the support structures 21.

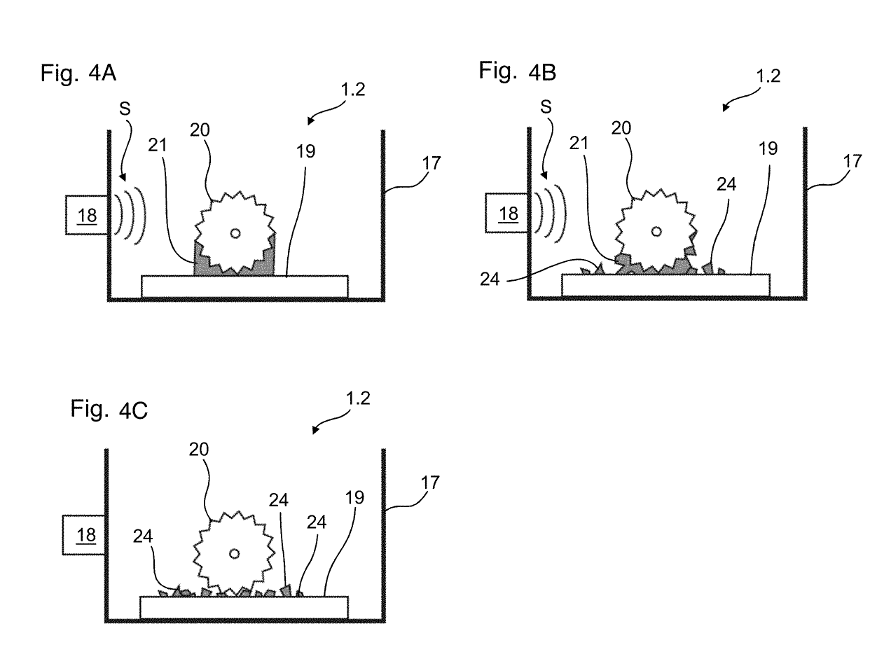

FIGS. 4A-4C show an alternative variant for removal of the support structures 21, in which the baseplate 19 together with the workpiece 20 and the support structures 21 are positioned in a container 17 connected to an ultrasound generator 18. After activation of the ultrasound generator 18, it generates mechanical vibrations or soundwaves S in the ultrasound region that propagate into the support structures 21 firstly via the wall of the container 17 and the baseplate 19, and secondly via the air. The frequency of these soundwaves S is chosen such that they lead to breakup of the binder matrix 22. This gradually breaks down into fragments 24 (see FIG. 4B), until the workpiece 20 and the baseplate 19 are ultimately exposed (see FIG. 4C). Under some circumstances, it may be advantageous to fill the container 17 with a liquid through which the soundwaves S can propagate. This liquid could even be a solvent 16, which means that the variants shown in FIGS. 3A-3C and in FIGS. 4A-4C can advantageously be combined. The mechanical breakup of the binder matrix 22 and the dissolution thereof can take place in parallel to one another.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

As used herein, the phrase at least one of A, B, and C should be construed to mean a logical (A OR B OR C), using a non-exclusive logical OR, and should not be construed to mean “at least one of A, at least one of B, and at least one of C.

What is claimed is:

1. An additive manufacturing method comprising:
manufacturing a workpiece in a manufacturing area by applying metallic powder with a first application device layer by layer to a base body, melting the metallic powder in first regions with a laser beam, and solidifying the metallic powder of the first regions;
producing support structures that connect the workpiece to the base body by applying a binder to second regions of the metallic powder with a second application device and solidifying the metallic powder of the second regions such that a powder-binding binder matrix is formed; and
removing the support structures from the workpiece after completion thereof by a degradation process such that the powder-binding binder matrix is broken up and the workpiece is stable.

2. The manufacturing method as claimed in claim 1, wherein the degradation process also acts at least on regions of the workpiece.

3. The manufacturing method as claimed in claim 1, wherein the powder-binding binder matrix is broken up by a mechanical vibration.

4. The manufacturing method as claimed in claim 3, wherein the mechanical vibration is produced by an ultrasound generator.

5. The manufacturing method as claimed in claim 1, wherein the powder-binding binder matrix is dissolved by action of a liquid solvent.

6. The manufacturing method as claimed in claim 5, wherein the support structures make contact with the liquid solvent by at least one of dipping, pouring, and spraying.

7. The manufacturing method as claimed in claim 1, wherein movement of the second application device is coupled to or independent from a movement of the first application device.

8. The manufacturing method as claimed in claim 1, wherein the base body and the workpiece are removed from the manufacturing area after completion thereof and transported into a processing area in which the support structures are removed.

9. The manufacturing method as claimed in claim 1, wherein the support structures are removed from the base body by the degradation process and the base body remains stable with respect to the degradation process.

10. The manufacturing method as claimed in claim 1 further comprising reusing at least one of the base body and powder bound intermediately in the powder-binding binder matrix after the removal of the support structures.

11. An additive manufacturing method comprising:
applying metallic powder layers to a base body using a first application device;
melting first regions of the layers to produce a workpiece;
applying a binder to second regions of the layers using a second application device to produce a binder matrix, the binder matrix forming support structures that support the workpiece relative to the base body; and
removing the support structures.

12. The additive manufacturing method as claimed in claim 11, wherein movement of the first application device and second application device are independent of one another.

13. The additive manufacturing method as claimed in claim 11, wherein the first application device and the second application device work in parallel of one another.

14. The additive manufacturing method as claimed in claim 11, wherein the support structures are removed by a degradation process.

15. The additive manufacturing method as claimed in claim 14, wherein the degradation process comprises soundwaves generated by an ultrasound generator.

16. The additive manufacturing method as claimed in claim 14, wherein the degradation process comprises dissolving the support structures in a liquid solvent.

17. The additive manufacturing method as claimed in claim 16, wherein the dissolution of the support structures are accelerated by mechanical vibrations.

18. The additive manufacturing method as claimed in claim 14, wherein at least a portion of the workpiece is exposed to the degradation process.

19. The additive manufacturing method as claimed in claim 11, further comprising reusing at least one of the base body and powder bound intermediately in the binder matrix after the support structures are removed.

20. The additive manufacturing method as claimed in claim 11, further comprising applying a laser beam to the first regions to melt the first regions of the layers to produce the workpiece.
